(19) United States
(12) Patent Application Publication
(10) Pub. No.: US 2006/0021027 A1
(43) Pub. Date: Jan. 26, 2006

(54) Personal information management apparatus, personal information file creation method, and personal information file search method

(75) Inventor: Takashi Saito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/167,758

(22) Filed: Jun. 27, 2005

(30) Foreign Application Priority Data
Jun. 28, 2004 (JP) P2004-189617

(51) Int. Cl. G06F 12/14

(52) U.S. Cl. 726/18

(57) ABSTRACT

A personal information management apparatus includes an imaging device having an imaging device for photo-taking a subject in which a person and an information medium containing character information about the person are a set with one photo-taking; an image extraction device extracting face image data and information medium image data among the subject image data generated by the photo-taking of the imaging device; a personal information file creation device creating a personal information file in such a manner that the face image data and the information medium image data are associated with each other; and a storage device storing one or more personal information files.

### CROSS REFERENCES TO RELATED APPLICATIONS

The present invention contains subject matter related to Japanese Patent Application JP 2004-189617 filed in the Japanese Patent Office on Jun. 28, 2004, the entire contents of which are incorporated herein by reference.

### BACKGROUND OF THE INVENTION

1. Field of the Invention

The present invention relates to a personal information management apparatus capable of photo-taking a subject, a personal information file creation method for creating a personal information file on the basis of a photo-taken image, and a personal information file search method.

2. Description of the Related Art

Hitherto, in general, business cards that are exchanged are stored in a business card holder and are utilized when a contact with the card exchanged party is made at a later date.

In order to prevent a situation where it is difficult to remember the face of the other party by only viewing the business card stored in the business card holder and even if you encounter the card exchanged party, you go by without noticing him/her, a business card holder capable of photo-taking the face image of the card exchanged party and also capable of photo-taking the business card has been proposed.

### SUMMARY OF THE INVENTION

However, even if the face of the card exchanged party is photo-taken, a user needs to memorize the business card and the face of the card exchanged party until the business card is photo-taken later, and the efficiency of the personal information file creation process for managing business cards and the face images of the business cards is considerably poor.

Furthermore, even if face images and business card images are managed as a personal information file, there is no means for efficiently searching for a personal information file, and the user needs to search for a target file while the face images and the business card images are displayed in a one-by-one manner.

The present invention has been made in view of the above-described problems. It is desirable to provide a new and improved personal information management apparatus capable of photo-taking the correspondence between business cards and faces without errors and capable of appropriately and efficiently creating or searching for a personal information file, a personal information file creation method, and a personal information file search method.

According to an embodiment of the present invention, there is provided a personal information management apparatus including: an imaging device having imaging means for photo-taking a subject in which a person and an information medium containing character information about the person are a set with one photo-taking; image extraction means extracting face image data and information medium image data among the subject image data generated by the photo-taking of the imaging device; personal information file creation means creating a personal information file in such a manner that the face image data and the information medium image data are associated with each other; and a storage device storing one or more personal information files.

According to the embodiment of the present invention, in the personal information management apparatus, as a result of releasing a shutter once, a subject in which at least a card exchanged person and the business card of that person are a set is photo-taken to generate subject image data. Furthermore, with respect to the subject image data, the face portion and the business card portion are each automatically recognized and extracted; the face image data and the business card image data are obtained; and a personal information file is created. According to such a configuration, both the face and the business card can be photo-taken collectively in one simple and easy operation, incorrectly corresponding the business card image of another person will not occur after photo-taking, and a personal information file can be created automatically. For creating the personal information file according to the embodiment of the present invention, one personal information file may be created, for example, by making face image data and business card image data correspond to each other.

The imaging means may be configured to be panorama imaging means capable of photo-taking at least a 180 degree full view. According to such a configuration, a person can be entirely photo-taken at the position facing the business card inserted into the personal information management apparatus. The panorama imaging means according to the embodiment of the present invention may photo-take, for example, a 360 degree full view.

The personal information file creation means may create the personal information file in such a manner that at least one of speech data of the subject, temperature data indicating the temperature when the subject was photo-taken, and the photo-taken position data indicating the position at which the subject was photo-taken is further associated. According to such a configuration, related information and attribute information of the business card or the person related to the business card can be managed collectively in the personal information file.

The personal information management apparatus may further include text data generation means for recognizing characters contained in the extracted business card image data and for generating text data from the recognized characters. The personal information file creation means may create a personal information file by making the text data to be further associated. For creating the personal information file according to the embodiment of the present invention, one personal information file may be created, for example, by making the business card image data, the face image data, and the text data correspond to one another.

According to another embodiment of the present invention, there is provided a personal information management apparatus including: a storage device storing a personal information file in which face image data generated by photo-taking once a subject in which a person and an information medium containing character information about the person are a set, and information medium image data are associated with each other; input accepting means accepting an input of search conditions for searching for the personal information file; and search means searching for a personal information file that satisfies the search conditions.

According to the embodiment of the present invention, various kinds of data contained in the created personal information file can be made to be search conditions. According to such a configuration, when a personal information file desired by the user is to be searched from the personal information files, as a result of setting the photo-taken date and time when the business card/face image contained in the personal information file was photo-taken, the photo-taken position, a separately photo-taken business card/face image, etc., as search conditions, a desired personal information file can be searched quickly and appropriately.

The input accepting means may accept at least face image data specified as search conditions, and the search means may compare the face image data contained in the accepted search conditions with the face image data contained in the personal information file and may obtain a personal information file associated with resembling or matching face image data.

The input accepting means may accept at least information medium image data specified as search conditions, and the search means may compare the information medium image data contained in the accepted search conditions with the information medium image data contained in the personal information file and may obtain a personal information file associated with resembling or matching information medium image data. According to such a configuration, a personal information file containing target information medium image data can be easily searched for without recognizing characters from the information medium image data and converting the characters into text.

The personal information file is further associated with text data of characters recognized from the information medium image data, the input accepting means may accept at least text data as search conditions, and the search means may compare the text data contained in the accepted search conditions with the text data contained in the personal information file and may obtain a personal information file associated with resembling or matching text data. The personal information management apparatus may further include list display means for list-displaying searched personal information files.

According to another embodiment of the present invention, there is provided a personal information file creation method for creating a personal information file, including the steps of: photo-taking a subject in which a person and an information medium containing character information about the person are a set with one photo-taking; extracting face image data and information medium image data among the subject image data generated by the photo-taking of the imaging device; creating a personal information file in such a manner that the face image data and the information medium image data are associated with each other; and storing the created personal information files in a storage device. The personal information file creation method may create one personal information file, for example, by making face image data and business card image data correspond to each other.

The imaging step may photo-take at least a 180 degree full view. According to such a configuration, a person can be entirely photo-taken at the position facing the business card inserted into the personal information management apparatus. The imaging step according to the embodiment of the present invention may panorama photo-take, for example, a 360 degree full view.

The personal information file creation step may create the personal information file in such a manner that at least one of speech data of the subject, temperature data when the subject was photo-taken, and photo-taken position data indicating the position at which the subject was photo-taken is further associated.

The personal information file creation method may further include steps of recognizing characters contained in the extracted information medium image data and generating text data from the recognized characters, and the personal information file may be created in such a manner that the text data is further associated. The personal information file creation method according to the embodiment of the present invention may be implemented in such a way that one personal information file is created in such a way that, for example, the face image data, the business card image data, and the text data are made to correspond to one another.

According to another embodiment of the present invention, there is provided a personal information file search method for searching for a personal information file. The personal information file search method includes the steps of: prestoring, in a storage device, a personal information file in which face image data generated by photo-taking once a subject in which a person and an information medium containing character information about the person are a set, and information medium image data are associated with each other; accepting an input of search conditions for searching for a personal information file; and searching for a personal information file that satisfies the search conditions.

The input accepting step may accept at least face image data specified as search conditions, and the search step may compare the face image data specified as the accepted search conditions with the face image data contained in the personal information file and may obtain a personal information file associated with resembling or matching face image data.

The input accepting step may accept at least information medium image data specified as search conditions, and the search step may compare the information medium image data contained in the accepted search conditions with the information medium data contained in the personal information file and may obtain a personal information file associated with resembling or matching information medium image data.

The personal information file may be further associated with text data of the characters recognized from the information medium image data, the input accepting step may accept at least text data as search conditions, and the search step may compare the text data contained in the accepted search conditions with the text data contained in the personal information file and may obtain a personal information file associated with resembling or matching text data.

The personal information file search method may further include a step of list-displaying searched personal information files.

As described in the foregoing, according to the embodiments of the present invention, since a subject in which a business card and a person are a set can be photo-taken with one photo-taking process, the business card and the face image typically match each other, and the personal information management apparatus can be created appropriately.

Furthermore, in the created personal information file, in addition to the business card image or the face image, the photo-taken position, temperature, the speech of the person, and the like can be contained. Therefore, even if the name of the person is forgotten, the personal information file of the person, desired by the user, can be efficiently searched on the basis of various search conditions other than that name.

### BRIEF DESCRIPTION OF THE DRAWINGS

FIG. 1 is an illustration schematically showing the configuration of a personal information management apparatus according to an embodiment of the present invention;

FIG. 2 is a block diagram schematically showing the configuration of the personal information management apparatus according to the embodiment of the present invention;

FIG. 3 is a block diagram schematically showing the configuration of a data processing unit according to the embodiment of the present invention;

FIG. 4 is a flowchart showing an overview of a series of operations of the personal information management apparatus according to the embodiment of the present invention;

FIG. 5 is a flowchart showing an overview of a personal information file creation process according to the embodiment of the present invention;

FIG. 6 is a flowchart showing an overview of a business card/face image obtaining process according to the embodiment of the present invention;

FIGS. 7A, 7B, and 7C are illustrations showing an overview of the business card/face image obtaining process according to the embodiment of the present invention;

FIG. 8 is an illustration schematically showing the structure of a personal information file according to the embodiment of the present invention;

FIG. 9 is a flowchart showing an overview of a search process for searching for a personal information file according to the embodiment of the present invention; and

FIG. 10 is a flowchart showing an overview of a business card/face image search process according to the embodiment of the present invention.

### DESCRIPTION OF THE PREFERRED EMBODIMENTS

Preferred embodiments of the present invention will now be described below in detail with reference to the attached drawings. In this specification and the drawings, components having substantially identical functions are designated with the same reference numerals, and thus, a duplicate description is omitted.

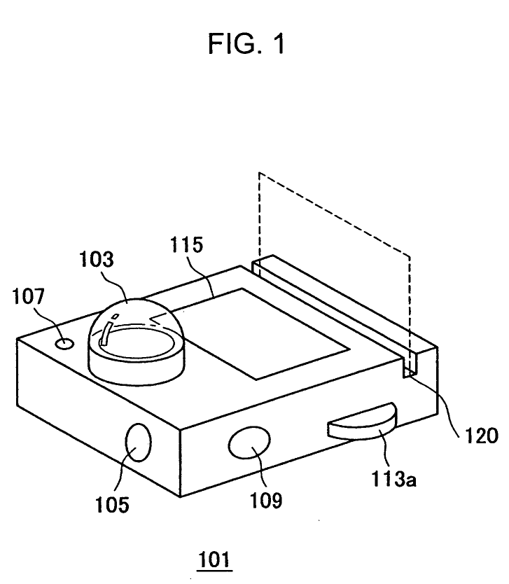

Referring to FIG. 1, a personal information management apparatus 101 according to this embodiment is described first. FIG. 1 is an illustration schematically showing the configuration of a personal information management apparatus according to the embodiment.

As shown in FIG. 1, the personal information management apparatus 101 includes a panorama imaging section (panorama imaging means) 103, a zoom imaging section 105, a speech input section 107, a shutter section 109, an input section 113a, a display section 115, and a recessed section 120.

The panorama imaging section 103 has a semi-circular lens and is able to photo-take a 360 degree full view. Therefore, if the shutter is released once by using the shutter section 109, for example, even if a person and the business card of that person are located at separate places, it is possible to photo-take them within one subject.

Since the focal length of the panorama imaging section 103 is in the range of, for example, several centimeters to infinity, it is possible to simultaneously photo-take a subject as close as several centimeters from the panorama imaging section 103 and a subject as far as several meters.

The panorama imaging section 103 according to this embodiment is described by using, as an example, a case in which a 360 degree full view is panorama photo-taken. However, the panorama imaging section 103 is not restricted to such an example and can be used to panorama photo-take, for example, a 180 degree view or a 270 degree view.

The zoom imaging section 105 is able to photo-take a subject by zoom-in or by zoom-out. Even if the zoom photo-taking section 105 does not photo-take using the panorama imaging section 103, for example, the zoom imaging section 105 can photo-take a person at the first shutter release and can photo-take the business card of that person at the second shutter release. Thus, if images in which a person and a business card re continuous is used, a personal information file (to be described later) can be created.

The light from the subject via the panorama imaging section 103 or the zoom imaging section 105 is received by an imaging element (not shown) provided in the imaging device. The imaging element (imaging device) can photoelectrically convert an optical image received from the subject and output it as an electrical image signal by using a plurality of pixels made up of photoelectric conversion element provided in a two-dimensional amplifier on the light-receiving surface. Examples of the imaging element include a solid-state imaging device such as various kinds of CCDS.

For the speech input section 107, a directional microphone can be shown as an example. The speech input section 107 makes it possible to, for example, collect speech produced by a person and to generate speech data. The speech data is stored in a personal information file (to be described later).

For the shutter section 109, a shutter button that releases a shutter to photo-take a subject can be shown as an example. As long as a shutter can be released, the shutter section 109 is not restricted to such an example and may be in any form.

The input section 113a is a jog dial. For example, a user switches the menu items, etc., by using the input section 113a in order to perform various kinds of setting while referring to the menu screen displayed on the display section 115.

For the display section 115, a liquid-crystal display device such as an LCD can be shown as an example, and the display section 115 is used to confirm the subject image after photo-taking. Also, the display section 115 according to this embodiment can output a moving image in addition to a still image.

The recessed section 120 can place a business card in position by inserting the business card into the groove. If the business card is inserted into the recessed section 120, the panorama imaging section 103 can photo-take the business card while being inserted. The recessed section 120 according to this embodiment may be further provided with fixation means such as a clip in order to place the business card in position.

The shape of the recessed section 120 according to this embodiment may be any shape, for example, a V groove shape, as long as the business card can be inserted and fixed to a certain degree.

The imaging device for photo-taking a subject according to this embodiment includes at least, for example, the panorama imaging section 103, the zoom imaging section 105, the shutter section 109, and the display section 115, but is not restricted to such an example.

The personal information management apparatus 101 according to this embodiment is described by using as an example a case in which a subject is photo-taken as a still image, but is not restricted to such an example. For example, the personal information management apparatus 101 may be used in a case in which a moving image is photo-taken.

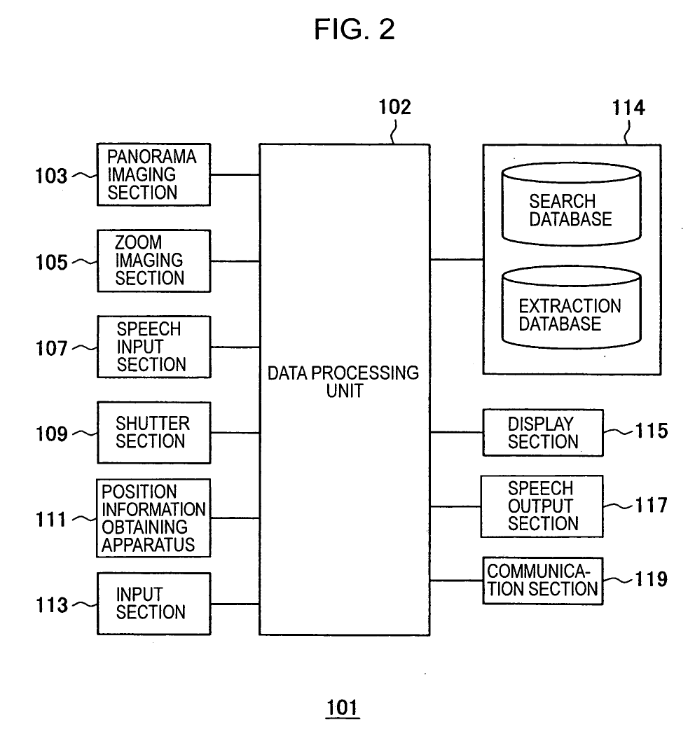

Next, a description is given, with reference to FIG. 2, of each section provided in the personal information management apparatus 101. FIG. 2 is a block diagram schematically showing the configuration of the personal information management apparatus according to this embodiment.

As shown in FIG. 2, as described above, the personal information management apparatus 101 includes the panorama imaging section 103, the zoom imaging section 105, the speech input section 107, the shutter section 109, the input section 113, and the display section 115.

Furthermore, in addition to the above, the personal information management apparatus 101 includes a data processing unit 102, a position information obtaining apparatus 111, a storage device 114, a speech output section 117, and a communication section 119.

The data processing unit 102 performs various kinds of data processing, such as recognizing a face image and extracting face image data from subject image data, by using the subject image data photo-taken by the panorama imaging section 103. The data processing unit 102 can also perform color correction of luminance, chroma and the like among image processing as necessary.

The storage device 114 is a data storage device formed by, for example, a small hard disk drive (HDD) and a flash memory, and can store various kinds of databases, such as a search database (search DB) and an extraction database (extraction DB), and various kinds of data, such as subject image data and face image data.

The storage device 114, as shown in FIG. 2, stores at least the search DB and the extraction DB. In the extraction DB, sample image data of the business card image data or the face image data for extracting the business card image data or the face image data from the subject image data, is stored.

For the sample image data, for example, in the case of a human face, face image data generated from an average face that is determined from a plurality of faces is set as sample image data. If general face image data is contained in the subject image data, the face image data formed of the face portion can be recognized and that region can be extracted. In the case of the business card, also, sample image data is stored similarly to the case of the face image. The sample image data according to this embodiment is described by using as an example the case of a business card or a face. However, the sample image data is not restricted to such an example, and can be implemented, for example, in the case of an animal, such as a dog or a cat and in the case of an automobile.

In the search DB, a personal information file created by photo-taking a subject is stored. The personal information file is digital data containing attribute data, such as text data of characters written in the business card and photo-taken position data indicating the photo-taken position, as well as the face image data and the business card image data of each person. The personal information file will be described later in detail.

The position information obtaining apparatus 111 has a function for specifying a position by using GPS (Global Positioning System) or PHS (Personal Handyphone System).

Whereas the GPS specifies the position by measuring the position by using two or three GPS satellites, the PHS specifies the position by the intensity of the radio waves emitted from the position information obtaining apparatus 111 to a base station.

The position information obtaining apparatus 111, by being provided in the personal information management apparatus 101, generates photo-taken position data indicating the position at which the subject was photo-taken. As a result of the photo-taken position data being contained in the personal information file, if the position is specified as the search conditions during a search, the personal information file containing the subject image data that was photo-taken at that position in the past can be searched efficiently. The process for searching for the personal information file will be described later.

The position information obtaining apparatus 111 according to this embodiment is described by using as an example a case in which the position information obtaining apparatus 111 is incorporated in the personal information management apparatus 101, but is not restricted to such an example. For example, the position information obtaining apparatus 111 can be implemented even when the position information obtaining apparatus 111 is externally connected to the personal information management apparatus 101 via a serial cable.

The input section 113 can be implemented when it is formed of, in addition to the above-described joystick, for example, a pointing device, such as a mouse, a track ball, a track pad, a stylus pen, or a joystick, which is capable of receiving operation instructions from the user, operation means, such as a keyboard, buttons, a switch, and a lever, and an input control section for generating an input signal and outputting it to the CPU 102.

The communication section 119 is, for example, a communication interface formed of a communication line, a communication circuit, a communication device, etc. The communication section 119 is used, for example, when an HDD is externally connected for expansion or when a connection with a network, such as the Internet, is made.

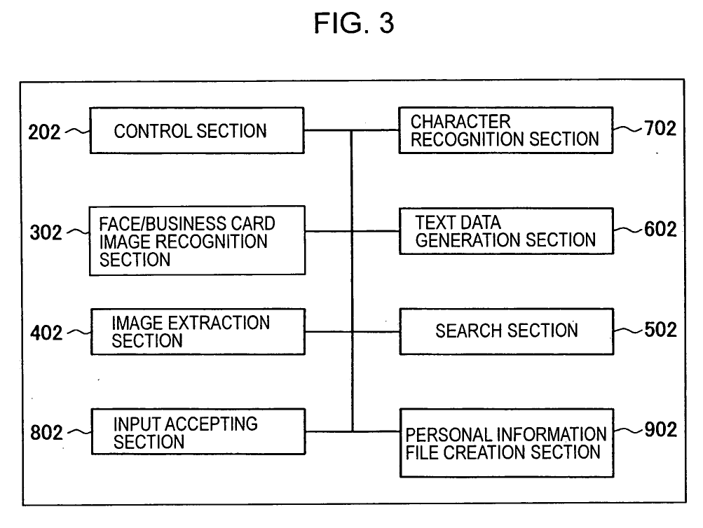

Next, a description is given, with reference to FIG. 3, of the data processing unit 102 according to this embodiment. FIG. 3 is a block diagram schematically showing the configuration of a data processing unit according to this embodiment.

As shown in FIG. 3, the data processing unit 102 includes a control section 202, a face/business card image recognition section 302, an image extraction section 402, a search section 502, a text data generation section 602, a character recognition section 702, an input accepting section 802, and a personal information file creation section 902.

The control section 202 has a computation processing or control function and controls processing performed by each section, for example, as a result of issuing a command to each section. The face/business card image recognition section 302 recognizes the portion corresponding to the face or the business card (the face image data or the business card image data) from the subject image data photo-taken by the panorama imaging section 103 or the like.

The face/business card image recognition section 302 according to this embodiment is described by using as an example the case of hardware having a function for recognizing face image data or business card image data from subject image data. However, the face/business card image recognition section 302 is not restricted to such an example, and the face/business card image recognition section 302 may be implemented in the case of software formed of one or more modules or components.

The image extraction section 402 extracts the portion (region) associated with face image data or business card image data recognized by the face/business card image recognition section 302 in order to extract face image data or business card image data.

The image extraction section 402 according to this embodiment is described by using as an example the case of hardware having functions for cutting out and extracting face image data or business card image data recognized by the face/business card image recognition section 302, but is not restricted to such an example. The image extraction section 402 may be implemented, for example, in the case of software formed of one or more modules or components.

Based on the search conditions obtained from the input accepting section 802, the search section 502 searches for a personal information file matching the search conditions. The search section 502 may be implemented even when a personal information file that exactly matches the search conditions is searched for or when a personal information file that partially matches the search conditions is searched for.

The character recognition section 702 has functions for recognizing a portion, which are characters, among the image of the business card image data. The text data generation section 602 extracts the business card image data of the portion of the characters recognized by the character recognition section 702 and converts the portion of the characters into text in order to generate text data. The character recognition section 702 and the text data generation section 602 correspond to, for example, so-called OCR (Optical Character Recognition), but are not restricted to such an example.

The input accepting section 802 is an interface for accepting instructions, search conditions, etc., input by the input section 113 and allows the control section 202 to transmit them as instruction data and search condition data to each section. For example, when the search conditions are input in the input section 113, the input accepting section 802 accepts the search condition data and transmits the search condition data to the search section 502.

When the speech data, the face image data, or the business card image data is generated, the personal information file creation section 902 creates a personal information file for collectively managing them. The personal information file creation section 902 according to this embodiment is described by using as an example the case of hardware having a function for creating a personal information file, but is not restricted to such an example. For example, the personal information file creation section 902 may be implemented even in the case of software formed of one or more modules or components.

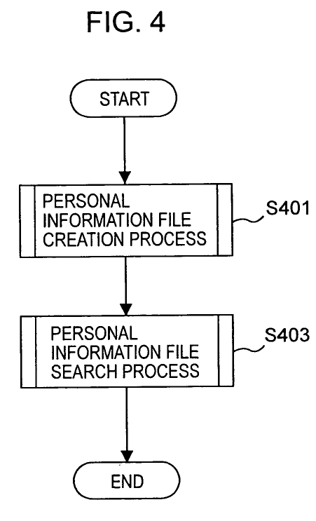

Next, a description will be given below, with reference to FIG. 4, of a series of operations of the personal information management apparatus 101 according to this embodiment. FIG. 4 is a flowchart showing an overview of a series of operations of the personal information management apparatus according to this embodiment.

As shown in FIG. 4, the personal information management apparatus 101 according to this embodiment is broadly classified into two processes, that is, a personal information file creation process (S401) for creating a personal information file and a personal information file search process for searching for a personal information file. The personal information file creation process (S401) and the personal information file search process (S403) are described below.

(Personal Information File Creation Process)

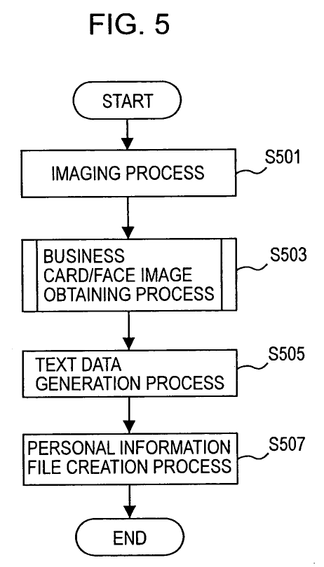

Here, referring to FIG. 5, a personal information file creation process according to this embodiment is described. FIG. 5 is a flowchart showing an overview of the personal information file creation process according to this embodiment.

As shown in FIG. 5, first, by releasing the shutter using the shutter section 109 provided in the personal information management apparatus 101, a subject is photo-taken (S501). In the subject imaging process (S501), as described above, the business card is inserted into the recessed section 120 provided in the personal information management apparatus 101 and is fixed so that it does not move during photo-taking. The business card is inserted in such a manner that the side where the name of the business card is printed faces the panorama imaging section 103.

In a state in which the business card is fixed in the recessed section 120, as a result of the user, for example, depressing the shutter section 109 provided in the personal information management apparatus 101, the person who is the owner of the business card is photo-taken by the panorama imaging section 103. Since the panorama imaging section 103 is capable of panorama photo-taking a 360 degree full view, even if a person who is a subject exists in any direction, the subject in which the business card and the person thereof are a set can be photo-taken by releasing the shutter once. Therefore, the business card and the person thereof can be photo-taken efficiently and quickly.

The imaging process (S501) according to this embodiment is described by using as an example a case in which a subject in which a business card and a person who is the owner of the business card are a set is photo-taken, but is not restricted to such an example. For example, the imaging process may be implemented when the business card is not inserted into the recessed section 120, the business card is first photo-taken by releasing the shutter for the first time by the zoom imaging section 105, and next, the person who is the owner of the business card is photo-taken by releasing the shutter for the second time by the zoom imaging section 105.

Next, when the subject is photo-taken by the panorama imaging section 103 (S501), subject image data is generated by the data processing unit 102, and a business card/face image obtaining process for extracting and obtaining face image data and business card image data among the subject image data is performed (S503).

(Business Card Image or Face Image Obtaining Process)

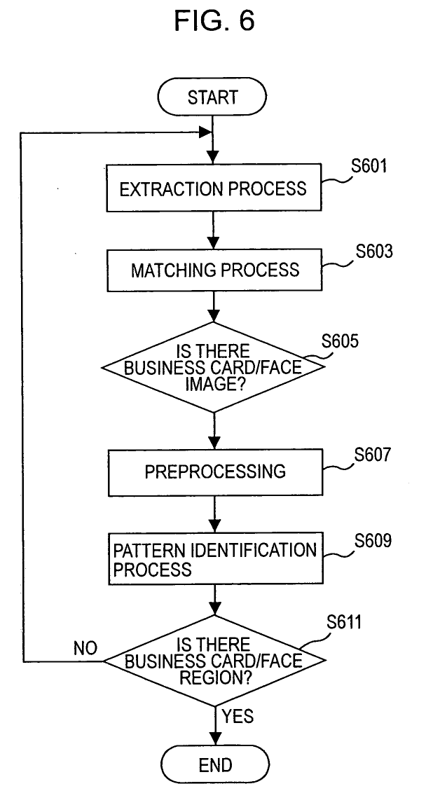

Here, referring to FIG. 6, the business card/face image obtaining process according to this embodiment is described. FIG. 6 is a flowchart showing an overview of the business card/face image obtaining process according to this embodiment. In the business card/face image obtaining process described below, the face image obtaining process is described in particular. However, the configuration of the business card image obtaining process is almost identical to that of the face image obtaining process.

As shown in FIG. 6, first, the subject image data is resized and is cut out to blocks of a predetermined region (S601). In the resizing of the subject image, the subject image data generated by the panorama imaging section 103 is read from the storage device 114 and is converted into a plurality of pieces of scale image data having mutually different reduction ratios.

For example, the subject image data according to this embodiment is reduced in sequence every 0.8 times and is converted into scale images of 5 stages (1.0 times, 0.8 times, 0.64 times, 0.51 times, and 0.41 times). Hereafter, for the above-described plurality of scale images, the scale image of 1.0 times is referred to as a first scale image, and are referred to as second to fifth scale images each time a reduction is made.

Next, when a plurality of pieces of scale image data are generated, a cutout process is performed on the scale image data (S601). In the extraction process, first, rectangular region s of 20×20 pixels (hereinafter referred to as a “window image”) are sequentially cut out by scanning, for example, the first scale image starting from the upper left of the image as the starting point and sequentially shifting by an appropriate number of pixels, for example, 2 pixels, up to the left right of the scale image. The starting point of the scale image data according to this embodiment is not restricted to the upper left of the image and can be implemented even if the starting point of the scale image data is, for example, the upper right of the image.

Next, for the plurality of pieces of window images cut out from the first scale image data, a subsequent template matching process (S603) is performed for each window image.

In the template matching processing (S603), a computation process, for example, a normalization correlation method or a means square error method, is performed on the window image data cut out in the process for cutting out scale image data (S601) so as to be converted into a function curve having a peak value, and thereafter, a threshold value that is low enough to such a degree that the recognition performance does not deteriorate with respect to the function curve is set, and a check is made to determine whether or not the region of the window image data is face image data by using the threshold value as a reference.

In the template matching process (S603), an average human face generated from the average of human face images of, for example, 100 persons is registered in advance as sample image data (template data) in the extraction DB of the storage device 114.

The determination as to whether or not the region of the window image data is a region of the face image data is performed in such a way that, as a result of sample image data being registered in advance in the template matching process (S603), a threshold value serving as a determination reference as to whether or not such window image data is face image data is set, and a simple and easy matching process with the sample image data is performed.

In the template matching process (S603), a process for performing a matching process between the cut-out window image data and the sample image data. When it is determined that the window image data matches the sample image data and is face image data (S605), the window image is assumed to be a score image (a window image determined as a face image), and subsequent preprocessing (S607) is performed.

When it is determined in the template matching process (S603) that the window image is not a face image (S605), the subsequent preprocessing (S607) and a pattern identification process (S609) are not performed on the window image. The score image data may contain reliability information indicating the level of the degree at which the window image is determined to be a face region is probable. For example, the reliability information represents the numerical value in which the score value is in the range of “00” to “99” and represents that the higher the numerical value is, the more probable the window image is a face region.

When the computation processes such as the normalization correlation method and the means square error method described above are compared to the computation processes in the subsequent preprocessing (S607) and the pattern identification process (support vector machine (SVM) identification processing: S609), the amount of computation process that is one tenth to one hundredth is necessary, and also, at the time of the matching process of the template matching process (S603), a window image, which is a face image, can be detected at the probability of 80(%) or more. That is, a window image that is clearly not a face image can be erased at this point in time.

In the preprocessing (S607) to be performed next, for example, in order to extract regions of four corners, corresponding to a background irrespective of the region of a human face image, from the score image data with respect to the score obtained from the template matching process (S603), the amount of 360 pixels is extracted from the score image of 20×20 pixels by using a mask in which the four corner regions are cut out. The score image according to this embodiment is described by using as an example a case in which the amount of 360 pixels in which the four corners are cut out is extracted, but is not restricted to such an example, and can be implemented even when the four corners are not cut out.

Furthermore, in the preprocessing (S607), in order to solve the gradient condition of the subject represented by dark and light due to the illumination during photo-taking, correction is made on the dark and light value of the score image data, such as the extracted 360 pixels, by using a computation method based on, for example, root mean square (RSM).

Then, a preprocessing section 233 performs a histogram smoothing process on the score image in which the contrast of the score image of the 360 pixels is accentuated. As a result, the score image becomes a score image that does not depend on the gain of the imaging device (not shown) provided in the personal information management apparatus 101 or on the intensity of the illumination.

Furthermore, in the preprocessing (S607), for example, in order to convert the score image data into vectors and to further convert the obtained vector group into one pattern vector, Gabor filtering processing is performed. The type of the filter in Gabor filtering can be changed as necessary.

Next, in a pattern identification process (S609), the face image data region is detected from the score image data obtained as a pattern vector in the preprocessing (S607).

In the pattern identification process (S609), with respect to the pattern vector generated in the preprocessing (S607), it is determined whether or not the region of the face image data exists within the region of the score image data. When the region of the face image is detected (S611), face image attribute information formed of, for example, the position of the score image (coordinate position), the area of the face image (the number of vertical×horizontal pixels), and the reliability information indicating the probability of being a face image, is stored.

As described above, with respect to the first scale image data, each processing by the subsequent template matching process (S603), preprocessing (S607), and the pattern identification process (S609), etc., is performed on the window image that is sequentially scanned by the extraction process (S601). Thus, a plurality of score images containing a face region can be detected from the first scale image data. Furthermore, almost the same processing as that of the first scale image is performed on the second to fifth scale images.

Therefore, as a result of one or more pieces of the face image attribute information being stored in the storage device 114, etc., it is possible for the face/business card image recognition section 302 to recognize the region of the portion of the face image data among the subject image data. Furthermore, it is possible for the image extraction section 402 to obtain the face image data. This completes the series of operations of the business card/face image obtaining process.

In the business card/face image obtaining process according to this embodiment, a description is given by using as an example a case in which business card/face image data is detected by a matching process using sample image data. However, the business card/face image obtaining process is not restricted to such an example, and can be implemented as long as business card/face image data can be detected.

(Face Image Data or Business Card Image Data)

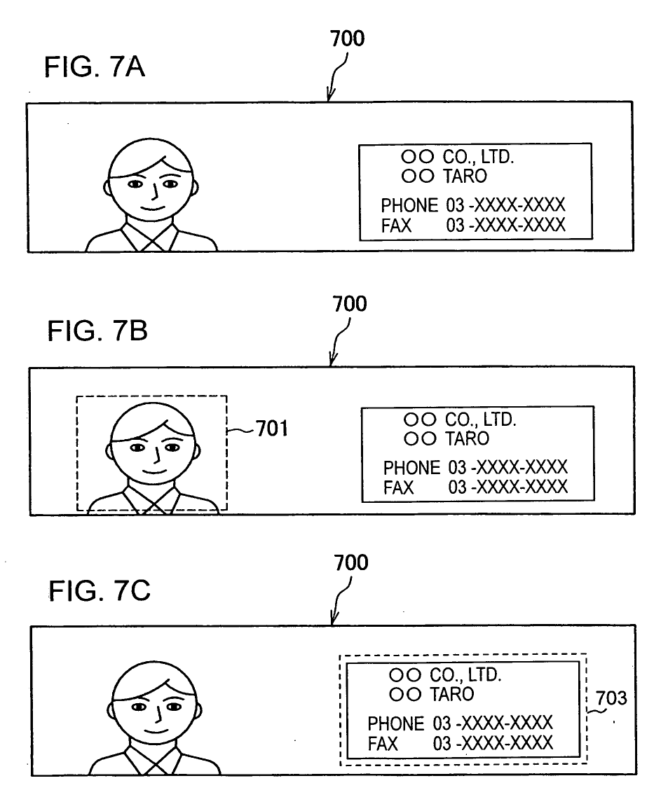

Here, referring to FIG. 7, a description is given of the face image data and the business card image data, which are extracted in the face image obtaining process and the business card image obtaining process according to this embodiment. FIGS. 7A, 7B, and 7C are illustrations showing an overview of the business card/face image obtaining process according to this embodiment.

As shown in FIG. 7A, first, when photo-taking is performed by the personal information management apparatus 101, subject image data 700 of a subject in which a business card and a person are a set is generated.

Next, when the subject image data 700 is generated, as shown in FIG. 7B, a region 701 containing face image data is recognized by the face/business card image recognition section 302. Furthermore, as shown in FIG. 7C, a region 703 containing business card image data is recognized by the face/business card image recognition section 302.

When the region 701 containing the face image data and the region 703 containing the business card image data are specified, the image extraction section 402 can obtain the face image data and the business card image data by extracting the region 701 and the region 703.

Referring back to FIG. 5, when the business card image or the face image is obtained (S503), next, text data is generated from the business card image data (S505).

As described above, in the text data generation process (S505), characters contained in the obtained business card image data are recognized, and text data corresponding to the characters is generated. As a process for generating text data, OCR can be shown as an example. The text data complies with, for example, JIS code, Shift JIS code, etc.

Next, when the text data is generated (S505), the personal information file creation section 902 performs a process for creating a personal information file (S507).

In the personal information file creation process, the personal information file is created (S507) as a result of the processing of S503 to S505 being performed and as a result of the generated face image data, the business card image data, the text data, and further, attribute data, such as the photo-taken position data obtained by the position information obtaining apparatus 111 during the imaging process (S501), speech data, and temperature data, being entirely incorporated in the personal information file.

The attribute data, such as the photo-taken position data and temperature data, according to this embodiment is described by using as an example a case in which the subject is photo-taken during the imaging process (S501) and is generated, but is not restricted to such an example. For example, after the imaging process (S501), the speech data, etc., may be generated once more. This completes the series of operations of the personal information file creation process according to this embodiment.

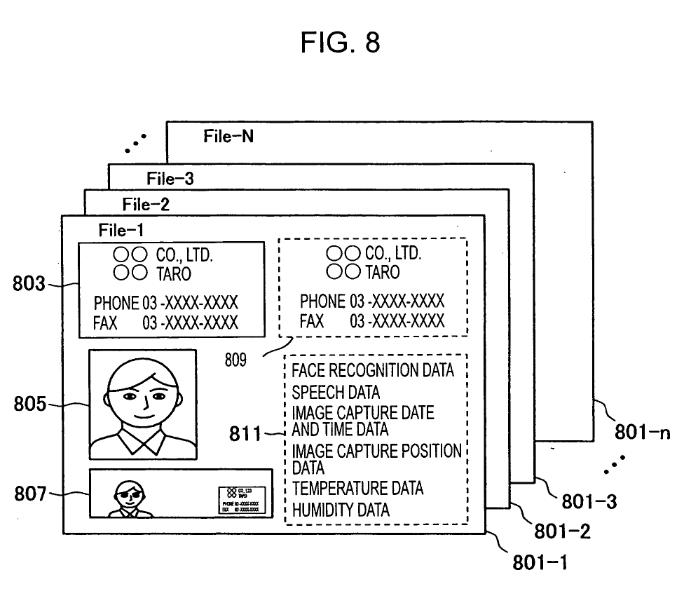

Next, a description is given, with reference to FIG. 8, of a personal information file according to this embodiment. FIG. 8 is an illustration showing the overall structure of the personal information file according to this embodiment.

One or more personal information files 801 (801-1, 801-2, 801-3, . . . , 801-n) shown in FIG. 8 are stored in the search DB of the storage device 114.

As shown in FIG. 8, as described above, the personal information file 801 includes at least subject image data 807, face image data 805, and business card image data 803 extracted from the subject image data, text data 809 such that character recognition is performed from the business card image data and data conversion is performed, and attribute data 811 made up of speech data and/or photo-taken day and time data.

The personal information file 801 is created in such a manner that the business card and the person of the owner of the business card have a one-to-one correspondence, but is not restricted to such an example. For example, the personal information file 801 can be implemented in a case in which there are a plurality of pieces of business card image data with respect to one piece of face image data.

(Personal Information File Search Process)

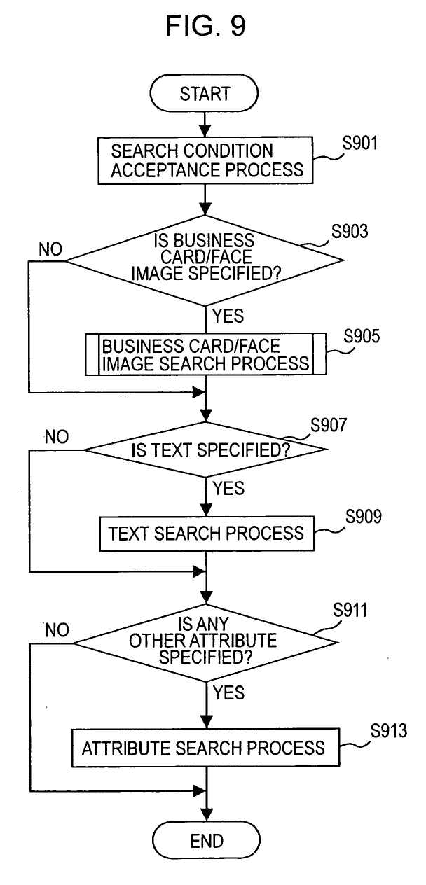

Next, a description is given, with reference to FIG. 9, of a personal information file search process according to this embodiment. FIG. 9 is a flowchart showing an overview of a search process for searching for a personal information file according to this embodiment.

As shown in FIG. 9, initially, a user operates the input section 113 in order to input search conditions, such as a keyword associated with a personal information file to be searched for. When the search conditions are input using the input section 113, the input accepting section 802 accepts the search conditions as search condition data (S901).

When the search condition data is accepted by the input accepting section 802, the search condition data is transmitted to the search section 502.

The search section 502 obtains the search condition data and confirms whether or not the business card image data or the face image data is specified in the search conditions (S903). When the business card image data or the face image data is set as the search conditions, a personal information file that exactly matches or partially matches the business card image data or the face image data can be searched for.

When the business card image data or the face image data is specified in the search conditions (S903), next, a business card/face image search process (S905) for searching for the business card image data or the face image data specified as the search conditions is performed.

(Business Card Image or Face Image Search Process)

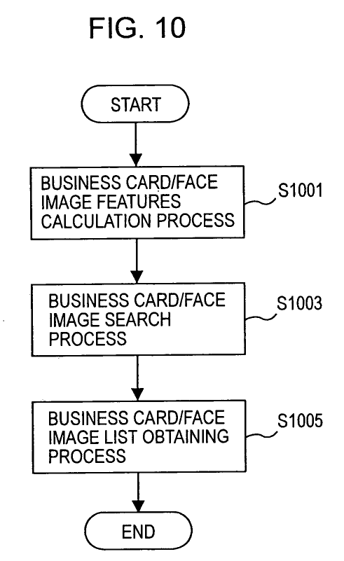

A description is given, with reference to FIG. 10, of a business card image/face image search process according to this embodiment. FIG. 10 is a flowchart showing an overview of the business card/face image search process according to this embodiment.

As shown in FIG. 10, initially, the features of the business card image data or the face image data set as the search conditions are calculated (S1001).

The features refer to luminance/color difference information, image frequency, histogram, etc., possessed by the image itself, such as the business card image data or the face image data. When the features are to be determined with respect to the business card image data or the face image data, the features are computed in such a way that the data is divided into a plurality of blocks, the average value of the luminance and color difference of the image is determined for each of the R, G, and B components in each block. Furthermore, the average value of the R, G, and B values is determined, and the average value of the whole is determined from each average value. For the block, a size of a predetermined region is determined in advance. THE FEATURES may be determined by providing a weight to each determined average value.

Similarly, also, with respect to the business card image data or the face image data incorporated in one or more personal information files stored in the search DB, the data is divided into a plurality of blocks, and the features are determined in each block. In the case of the features of the business card image data or the face image data incorporated in the personal information file, the features are determined in advance when the personal information file is created. The determination of the features are not restricted to such an example, and the features of the business card image data or the face image data incorporated in the personal information file may be determined during a search process.

The features according to this embodiment have been described by using as an example a case in which the features are determined for each block of the business card/face image. However, the determination of the features are not restricted to such an example, and may be implemented in a case where the features are determined, for example, in units of the business card image or the face image.

The features according to this embodiment have been described by using as an example a case in which the features are computed on the basis of the luminance and color difference information for each of the R, G, and B components and the average value of the R, G, and B values. However, the computation of the features is not restricted to such an example, and the features may be determined on the basis of a value such as a maximum value or a minimum value instead of the average value.

Next, when the features of the business card image data or the face image data are calculated (S1001), the business card image data or the face image data matching the calculated amount of features is searched for from the personal information file stored in the search DB (S1003).

When the business card image data or the face image data is searched for (S1003), the search process can be performed efficiently by calculating in advance the features with respect to the business card image data or the face image data contained in the personal information file and by allowing the features to be contained in the personal information file. However, the search process is not restricted to such an example, and can be implemented even when the features of the business card image data or the face image data contained in the personal information file are calculated for each file, for example, when the search process is performed.

In the search process (S1003), it is determined whether or not the features of each block, determined from the business card/face image specified in the search conditions, match or resemble the features of each block of the business card/face image on the personal information file side corresponding to the above block.

In the search process (S1003) according to this embodiment, the search process is not restricted to a case in which the amounts of features of the blocks on both the personal information file side and the search condition side exactly match, and can be implemented in a case in which a search is performed by determining that the features resemble if the features are within a predetermined threshold value.

When the number of times in which the features of each block match or resemble reaches a predetermined number of times, the search section 502 determines that the business card/face image data specified in the search conditions and the business card/face image data of the personal information file matches or resembles as a whole, and extracts the business card/face image data of the personal information file.

When the search process is performed as to whether or not there is data that satisfies the search conditions with respect to all the personal information files (S1003), the search section 502 obtains a list of the business card image data or the face image data searched as a result of the search process (S1005).

Next, referring back to FIG. 9, it is confirmed whether or not characters (text) are specified, such as a person designation, in the search conditions (S907). When the text is specified, a search as to whether or not the text specified as the search conditions exists in the text data 809 of the personal information file 801 is performed from the personal information files which have already been searched in S1005 (S909).

Furthermore, it is confirmed whether or not a search conditions of attribute, such as the photo-taken position, is set (S911). When the search conditions of attribute, such as temperature and the photo-taken position, are set, the personal information file associated with the attribute is searched from the personal information files which has already been searched in S909 (S913).

For example, when the user inputs the numerical values of latitude and longitude as the photo-taken position by operating the input section 113, it is possible for the search section 502 to search for a personal information file matching the photo-taken position on the basis of the photo-taken position data. The embodiments have been discussed above by using as an example a case in which the photo-taken position is specified by inputting the numerical values of latitude and longitude, but is not restricted to such an example. The embodiment can be implemented in a case where, for example, a map is displayed on the display section 115 and the photo-taken position is specified via the map.

Finally, the search section 502 displays a list of the personal information files searched in S913 on the display screen of the display section 115. This completes the series of the operations of the personal information file search process.

In the above-described embodiments, the personal information management apparatus 101 has been described by using as an example a case in which a subject is photo-taken as a still image. The present invention is not restricted to such an example. The personal information management apparatus 101 can be implemented even when a subject is photo-taken as a moving image.

In the above-described embodiment, the storage device 114 has been described by using as an example a case in which the storage device 114 is formed of a single flash memory. However, the storage device 114 is not restricted to such an example. For example, the storage device 114 may be provided with one or more additional flash memories as separate units. Furthermore, at least one of a RAM, a ROM, or a hard disk drive may be further provided.

In the above-described embodiment, the imaging process has been described by using as an example a case in which a business card and a person are entirely photo-taken as one subject by releasing the shutter once. However, the present invention is not restricted to such an example. The present invention can be implemented even when, for example, a business card and a person of that business card are photo-taken by separately releasing the shutter. In that case, for example, the personal information management apparatus may further include subject image data generation means so that the subject image data is generated by collectively combining as one set the face image data and the person image data, which are generated by continuously photo-taking the business card and the person.

The embodiments have been discussed above by using as an example a case in which each section provided in the personal information management apparatus 101 is formed of hardware. However, the present invention is not restricted to such an example. For example, each of the above-described sections may be a program formed of one or more modules or components.

The present invention can be applied to a personal information management apparatus for photo-taking a subject, a personal information file creation method for creating a personal information file on the basis of a photo-taken image, and a personal information file search method for searching for a personal information file.

It should be understood by those skilled in the art that various modifications, combinations, sub-combinations and alterations may occur depending on design requirements and other factors insofar as they are within the scope of the appended claims or the equivalents thereof.

What is claimed is:

1. A personal information management apparatus comprising:
an imaging device having imaging means for photo-taking a subject in which a person and an information medium containing character information about the person are a set with one photo-taking;
image extraction means extracting face image data and information medium image data among the subject image data generated by the photo-taking of the imaging device;
personal information file creation means creating a personal information file in such a manner that the face image data and the information medium image data are associated with each other; and
a storage device storing one or more personal information files.

2. The personal information management apparatus according to claim 1, wherein the imaging means is panorama imaging means capable of photo-taking at least a 180 degree full view.

3. The personal information management apparatus according to claim 1, wherein the personal information file creation means creates the personal information file in such a manner that at least one of speech data of the subject, temperature data when the subject was photo-taken, and photo-taken position data indicating the position at which the subject was photo-taken is further associated.

4. The personal information management apparatus according to claim 1, further comprising text data generation means recognizing characters contained in the extracted information medium image data and generating text data from the recognized characters,
wherein the personal information file creation means creates the personal information file in such a manner that the text data is further associated.

5. A personal information management apparatus comprising:
a storage device storing a personal information file in which face image data generated by photo-taking once a subject in which a person and an information medium containing character information about the person are a set, and information medium image data are associated with each other;
input accepting means accepting an input of search conditions for searching for the personal information file; and
search means searching for a personal information file that satisfies the search conditions.

6. The personal information management apparatus according to claim 5, wherein the input accepting means accepts at least face image data specified as search conditions, and
the search means compares the face image data contained in the accepted search conditions with the face image data contained in the personal information file and obtains a personal information file associated with resembling or matching face image data.

7. The personal information management apparatus according to claim 5, wherein the input accepting means accepts at least information medium image data specified as search conditions, and
the search means compares the information medium image data contained in the accepted search conditions with the information medium image data contained in the personal information file and obtains the personal information file associated with resembling or matching information medium image data.

8. The personal information management apparatus according to claim 5, wherein the personal information file is further associated with text data of characters recognized from the information medium image data,
the input accepting means accepts at least text data as search conditions, and
the search means compares the text data contained in the accepted search conditions with the text data contained in the personal information file and obtains a personal information file associated with resembling or matching text data.

9. The personal information management apparatus according to claim 5, further comprising list display means list-displaying searched personal information files.

10. A personal information file creation method for creating a personal information file, comprising the steps of:
photo-taking a subject in which a person and an information medium containing character information about the person are a set with one photo-taking;
extracting face image data and information medium image data among the subject image data generated by the photo-taking of the imaging device;
creating a personal information file in such a manner that the face image data and the information medium image data are associated with each other; and
storing the created personal information file in a storage device.

11. The personal information file creation method according to claim 10, wherein the imaging step photo-takes at least a 180 degree full view.

12. The personal information file creation method according to claim 10, wherein the personal information file creation step creates the personal information file in such a manner that at least one of speech data of the subject, temperature data when the subject was photo-taken, and photo-taken position data indicating the position at which the subject was photo-taken is further associated.

13. The personal information file creation method according to claim 10, further comprising steps of recognizing characters contained in the extracted information medium image data and generating text data from the recognized characters,
wherein the personal information file creation step creates the personal information file in such a manner that the text data is further associated.

14. A personal information file search method for searching for a personal information file, comprising the steps of:
prestoring, in a storage device, a personal information file in which face image data generated by photo-taking once a subject in which a person and an information medium containing character information about the person are a set, and information medium image data are associated with each other;
accepting an input of search conditions for searching for a personal information file; and
searching for a personal information file that satisfies the search conditions.

15. The personal information file search method according to claim 14, wherein the input accepting step accepts at least face image data specified as search conditions, and
the search step compares the face image data specified as the accepted search conditions with the face image data contained in the personal information file and obtains a personal information file associated with resembling or matching face image data.

16. The personal information file search method according to claim 14, wherein the input accepting step accepts at least information medium image data specified as search conditions, and
the search step compares the information medium image data contained in the accepted search conditions with the information medium data contained in the personal information file and obtains a personal information file associated with resembling or matching information medium image data.

17. The personal information file search method according to claim 14, wherein the personal information file is further associated with text data of the characters recognized from the information medium image data,
the input accepting step accepts at least text data as search conditions, and
the search step compares the text data contained in the accepted search conditions with the text data contained in the personal information file and obtains a personal information file associated with resembling or matching text data.

18. The personal information file search method according to claim 14, further comprising a step of list-displaying searched personal information files.

19. A personal information management apparatus comprising:
an imaging device having imaging means for photo-taking a subject in which a person and an information medium containing character information about the person are a set with one photo-taking;
an image extraction section extracting face image data and information medium image data among the subject image data generated by the photo-taking of the imaging device;
a personal information file creation section creating a personal information file in such a manner that the face image data and the information medium image data are associated with each other; and
a storage device storing one or more personal information files.

20. A personal information management apparatus comprising:
a storage device storing a personal information file in which face image data generated by photo-taking once a subject in which a person and an information medium containing character information about the person are a set, and information medium image data are associated with each other;
an input accepting section accepting an input of search conditions for searching for the personal information file; and
a search section searching for a personal information file that satisfies the search conditions.
